(19) United States
(12) Patent Application Publication
(10) Pub. No.: US 2025/0217322 A1
(43) Pub. Date: Jul. 3, 2025

(54) MASTER INGESTION AND DATA AUTOMATION PROCESS AND SYSTEM

(71) Applicant: THE DUN & BRADSTREET CORPORATION, Jacksonville, FL (US)

(72) Inventors: Norman Bahnck, JR., Fogelsville, PA (US); Shwetha Hegde, Long Valley, NJ (US); Kevin Bruce Downing, Bridgeton, PA (US); Jack Costagliola, Vero Beach, FL (US); Sirnath Reddy Busireddy, Austin, TX (US); Stephanie Anne Helfrich, Orefield, PA (US); Benjamin Zimmerman, Dublin, OH (US); Sheri Reaser, Allentown, PA (US); David Michael Earickson, St. Louis, MO (US); Siddharth Srivastav, Randolph, NJ (US)

(73) Assignee: THE DUN & BRADSTREET CORPORATION, Jacksonville, FL (US)

(21) Appl. No.: 19/001,037

(22) Filed: Dec. 24, 2024

Related U.S. Application Data
(60) Provisional application No. 63/615,864, filed on Dec. 29, 2023.

(51) Int. Cl. G06F 16/17; G06F 18/232

(52) U.S. Cl. CPC G06F 16/1734; G06F 18/232

(57) ABSTRACT

A master ingestion and data automation system which comprises: a source ingestion module which receives incoming files of meta data driven framework (MDD) which standardizes and normalizes data using source-specific rules; a recognizer engine which receives the incoming files to poll and recognize new files into the master ingestion and data automation system as recognized files; a loader which loads the recognized files into staging tables; a collection services engine, wherein the collection services engine processes the recognized files by: (i) collecting and/or creating at least one cluster of legal entities, names, and/or addresses; (ii) collecting data and capturing insights other than the legal entities, names, and/or addresses; and (iii) cluster data based on rules without storing the data redundantly; an evaluation and decisioning module that retrieves all of the data from the staging tables and/or the cluster data to determine which data to publish; and a publisher module which publishes output decisions from the evaluation and decisioning module.

### CROSS-REFERENCED APPLICATION

This application is a non-provisional of U.S. Provisional Application Ser. No. 63/615,864, filed on Dec. 29, 2023, which is incorporated herein by reference thereto in its entirety.

### BACKGROUND

### 1. Field

The present disclosure pertains to a new identity data universe that provides a higher level of flexibility to search across multiple data topics leading to more accurate entities being created and lower maintenance efforts. This is accomplished via a master reference database that captures and stores complete metadata on every piece of characteristic data that is ingested together with historical decision made. It is a robust data decisioning engine that can interpret incoming source data, compare it to existing data with serverless architecture having high end, auto-scalable computation methods leveraging Google Compute Engine (i.e., a virtual machine launched on demand) and GKE clusters (i.e., an orchestration platform).

### 2. Discussion of the Background Art

Conventional data matching processes have not yet been developed to facilitate the operational use case of a corporate identity number creation, such as a DUNS® Number, which undesirably leads to more manual intervention and data left on the floor. Latency in the corporate identity number creation process has always been a challenge, creating a delay for a user to be able to leverage their corporate identity number for their business interactions. Historically, corporate identity number creations took months and more recently that time frame has been reduced to 12-17 days, both of which are commercially unacceptable.

U.S. Pat. No. 8,051,049 (Remington et al.), entitled “Method and System for Providing Enhanced Matching from Customer Driven Queries” which was issued on Nov. 1, 2011, is one such system that provides enhanced matching for database queries. This system includes a data source; a data repository comprising a single-sourced reference file; a database comprising a multi-sourced reference file, the multi-sourced reference file having a first unique business identification number correspond to a business identification number corresponding to a business entity; and an intelligence engine processing incoming data from the data source. The intelligence engine determines whether the incoming data matches the multi-sourced reference file and adds the data to the multi-sourced reference file when the data matches the multi-sourced reference file. The intelligence engine also determines whether the incoming data matches a single-sourced reference file contained within the data repository when the data does not match the multi-sourced reference file.

The problem with conventional matching system and the intelligence engines is that they are incapable of processing name changes within an adequate time frame due to current time delays of 12 to 17 days in entity creation. These time delays cause undesirable duplication of records and incorrectly assigned trade data. The present disclosure seeks to overcome these time delays and duplication of records by (1) identifying and adding trade styles immediately as they become available, thus handing name changes, and (2) matching such trade styles to existing entities and addresses of potential duplicate records, thereby avoiding missing critical events, such as bankruptcies and merger and acquisition activities. The present disclosure accomplishes this by replacing the conventional intelligence engine and global matching units with the novel master ingestion and data automation system of the present disclosure which include a collection services unit and an evaluation and decisioning unit.

The present disclosure overcomes the deficiencies and latency in such corporate identity number creation by utilizing the unique process and system of the present disclosure which is able to create a corporate identity number within a few hours of receiving a new business registration. Moreover, businesses are not always known by their legal name and users may only have records of their trade style or an older name. Previously, this led to hundreds of thousands of name changes which were not processed within an adequate time frame as a result of this gap in functionality leading to duplicate records and incorrectly assigned trade data. The present invention solves this problem by identifying correct corporate identity and adding trade style immediately as such new corporate identities become available and leverage business registration data to handle such name changes.

Moreover, the present disclosure is capable of matching corporate entity searches to existing entities in the cloud, thereby addressing the millions of duplicates within the US or global dataset, thereby reducing the chance that users miss critical events like bankruptcies, and merger and acquisition activities.

The present disclosure also provides many additional advantages, which shall become apparent as described below.

### SUMMARY

The unique master ingestion and data automation system (MIDAS) and method of the present disclosure uses a collection services system to replace the conventional global match system together with a unique automated evaluation and decisioning engine. This new identity data universe provides a higher level of flexibility to search across multiple data topics leading to more accurate entities being created and lower maintenance efforts.

MIDAS will have a master reference database that captures and stores complete metadata on every piece of characteristic data that is ingested and historical decisions made. MIDAS is a robust data decisioning engine that can interpret incoming source data, compare it to existing data with serverless architecture with high end, auto-scalable computation methods leveraging a Google compute engine (i.e., a virtual machine launched on demand) and GKE clusters (i.e., an orchestration platform).

A master ingestion and data automation system which comprises: a source ingestion module which receives incoming files of MDD, i.e., a meta data driven framework which standardizes and normalizes data using source-specific rules, data; a recognizer engine which receives the incoming files to poll and recognize new files into the master ingestion and data automation system as recognized files; a loader which loads the recognized files into staging tables; a collection services engine, wherein the collection services engine processes the recognized files by: (i) collecting and/or creating at least one cluster of legal entities, names, and/or addresses; (ii) collecting data and capturing insights other than the legal entities, names, and/or addresses; and (iii) cluster data based on rules without storing the data redundantly; an evaluation and decisioning module that retrieves all of the data from the staging tables and/or the cluster data to determine which data to publish; and a publisher module which publishes output decisions from the evaluation and decisioning module.

The system wherein the incoming files are batch files. The system wherein the data from the staging tables and/or cluster data are identified by entries from an ingestion journal together with any related data comprising source domain and precedence.

The system wherein the collection services engine comprises at least one GKE cluster containing a python API. The system wherein the collection services engine comprises at least one collection service selected from the group consisting of: source organization collection service, name collection service, address collection service, phone collection service, industry codes/line of business collecting service, role player identification collection service, contact title collection service, contact details collection service, start year collection service, employee collection service, URL/email collection service, and combinations thereof.

The system wherein the data from the staging tables and/or the cluster data are stored in a collection service repository after being processed in the at least one collection service. The system wherein the cluster data is updates since the last decision for at least one cluster selected from the group consisting of: name clusters, address clusters, industry codes/line of business identification, contact details clusters, contact title collection, role player identification, employee clusters, and combinations thereof.

The system wherein the evaluation and decisioning module receives data from at least one data source selected from the group consisting of: the at least one collection service, source and domain precedence, Duns insight (i.e., do we have the record which requires updating or do we build a new record), metadata insight (i.e., refers to the quality of a source, when was the data first seen from the source, when was the data last seen from the source), cluster changes, and combinations thereof. The system wherein the data to publish is at least one selected from the group consisting of: file build, update (change/fill), confirm, wait, potential linkage, special handling (high risk), and additional match points.

A method for ingesting data automatically which comprises:
a. receiving incoming files of meta data driven framework (MDD), and using source-specific rules to standardize and normalize the data;
b. receiving the incoming files to poll and recognize new files into the master ingestion and data automation system as recognized files;
c. loading the recognized files into staging tables;
d. processing the recognized files via a collection services engine by:
   i. collecting and/or creating at least one cluster of legal entities, names, and/or addresses;
   ii. collecting data and capturing insights other than the legal entities, names, and/or addresses; and
   iii. cluster data based on rules without storing the data redundantly;
e. retrieving all of the data from the staging tables and/or the cluster data to determine which data to publish via an evaluation and decisioning module; and
f. publishing output decisions from the evaluation and decisioning module via a publisher module.

The incoming files are batch files.

The method further comprises identifying the data from the staging tables and/or cluster data by entries from an ingestion journal together with any related data comprising source domain and precedence.

The collection services engine comprises at least one GKE cluster containing a python API. The collection services engine comprises at least one collection service selected from the group consisting of: source organization collection service, name collection service, address collection service, phone collection service, industry codes/line of business collecting service, role player identification collection service, contact title collection service, contact details collection service, start year collection service, employee collection service, URL/email collection service, and combinations thereof.

The method wherein the data from the staging tables and/or the cluster data are stored in a collection service repository after being processed in the at least one collection service.

The method wherein the cluster data is updates since the last decision for at least one cluster selected from the group consisting of: name clusters, address clusters, industry codes/line of business identification, contact details clusters, contact title collection, role player identification, employee clusters, and combinations thereof.

The method wherein the evaluation and decisioning module receives data from at least one data source selected from the group consisting of: the at least one collection service, source and domain precedence, Duns insight, metadata insight, cluster changes, and combinations thereof.

The method wherein the data to be published is at least one selected from the group consisting of: file build, update (change/fill), confirm, wait, potential linkage, special handling (high risk), and additional match points.

A non-transitory computer readable storage media containing executable computer program instructions which when executed cause a processing system to perform a method for ingesting data automatically which comprises:
a. receiving incoming files of meta data driven framework (MDD), and using source-specific rules to standardize and normalize the data;
b. receiving the incoming files to poll and recognize new files into the master ingestion and data automation system as recognized files;
c. loading the recognized files into staging tables;
d. processing the recognized files via a collection services engine by:
   i. collecting and/or creating at least one cluster of legal entities, names, and/or addresses;
   ii. collecting data and capturing insights other than the legal entities, names, and/or addresses; and
   iii. cluster data based on rules without storing the data redundantly;
e. retrieving all of the data from the staging tables and/or the cluster data to determine which data to publish via an evaluation and decisioning module; and
f. publishing output decisions from the evaluation and decisioning module via a publisher module.

Further objects, features and advantages of the present disclosure will be understood by reference to the following drawings and detailed description.

### BRIEF DESCRIPTION OF THE DRAWINGS

FIG. 1 is process flow diagram of the master ingestion and data automation process and system according to the present disclosure;

FIG. 2 is the technology stack layers of the system architecture according to the present disclosure;

FIG. 3 is a high level process flow block diagram according to FIG. 1;

FIG. 4 is a description of the components used in the master ingestion and data automation process and system according to FIG. 3;

FIG. 5 is a data ingestion block diagram according to FIG. 3;

FIG. 6 is source organization collection service bloc diagram according to FIG. 3;

FIG. 7 is a name collection service block diagram according to FIG. 3;

FIG. 8 is an address collection service block diagram according to FIG. 3;

FIG. 9 is an industry code collection service block diagram according to FIG. 3;

FIG. 10 is a contact details collection service block diagram according to FIG. 3;

FIG. 11 is a contact title collection service block diagram according to FIG. 3;

FIG. 12 is a role player identification collection service block diagram according FIG. 3;

FIG. 13 is an employee collection service block diagram according to FIG. 3;

FIG. 14 is an evaluation/decisioning on cluster logic flow diagram according to FIG. 3;

FIG. 15 is an evaluation data preparation block diagram according to FIG. 3;

FIG. 16 is an evaluation impact analysis block diagram according to FIG. 3;

FIG. 17 is an evaluation actions block diagram according to FIG. 3;

FIG. 18 is an evaluation publishing block diagram according to FIG. 3;

FIG. 19 is example of a JSON structure with key-value pairs or properties according to the present disclosure;

FIG. 19A is an example of how the recognizer and loader unit of the process and system shown in FIG. 3 recognizes and loads to staging tables the data from FIG. 19;

FIG. 19B is an example of how collection services unit in FIG. 3 builds a name universe and identifying entities matching the name universe;

FIG. 19C is an example of how collection services unit in FIG. 4 builds an address universe and identifying entities matching the address universe;

FIG. 19D is an example of how the evaluation data identification services/decisioning engine forms a cluster set and generates an evaluation that the legal entity does not exist and wherein the decision taken is to build a new legal entity for the record in the stored database;

FIG. 20 is an example of the publishing via the publisher of FIG. 3 of the data generated from FIG. 19D;

FIG. 21 is a block diagram of the system according to the present disclosure;

FIG. 22A is a system flow of a MIDAS deployment diagram according to the present disclosure.

FIG. 22B is a more detailed flow of a MIDAS deployment diagram according to FIG. 22A.

### DETAILED DESCRIPTION OF THE PREFERRED EMBODIMENT

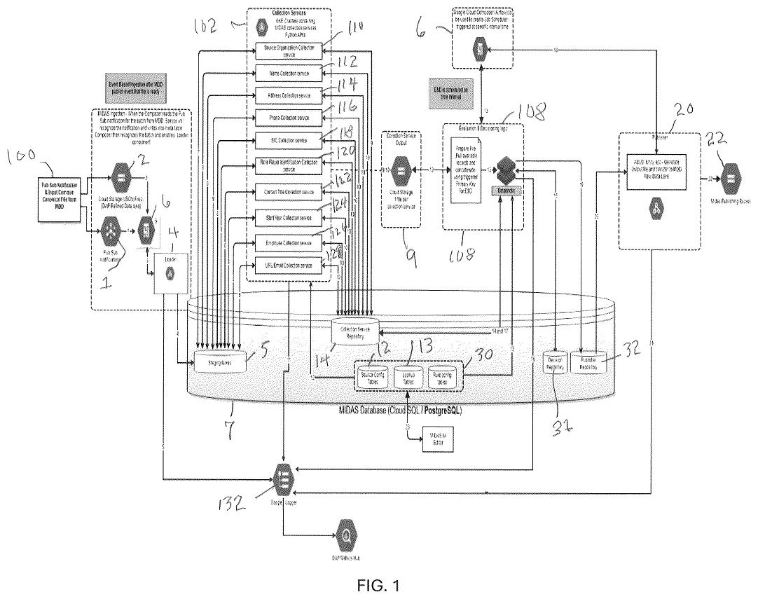

The present disclosure is best understood by reference to FIG. 1, wherein MIDAS cloud composer 6 (Airflow) will read the Pub Sub notification 1 from a meta data driven framework (MDD) 100 (i.e., a meta data driven framework which standardizes and normalizes data using source-specific rules and act as event based engine. Composer 5 will recognize the MDD notification 2. Composer 5 reads the batch from refined data lake 1 based on the batch details in the notification from MDD 100. Composer 6 invokes the loader 4 component which will decompose the JSON records 2 and load into staging tables 5 in MIDAS Repository 7.

While loading data into staging table 5, loader component 4 should ensure to set all the indicators as pre-requisite to collection services call. In addition to loading into staging table 5, loader 4 should then load the processing information into processing/audit table (not shown) which includes the ID details (batch ID, batch file path, batch status, priority, etc.,) ensuring validation of input source details with MIDAS source configuration and status of the batch. Loader 4 will also capture the audit information by writing structured log entries to GCP Cloud Logging 132, in GCP LogEntry JSON format.

Loader 4 will return to composer 6 once loading process is complete enabling composer 6 to call the Source Organization collection service 102. Based on the content of the input record in the JSON, GKE Clusters 104 spin up required number of instances of Source Organization Collection Service 102. Source Organization Collection Service 102 loads Source Organization tables and associated primary keys ensuring all the necessary primary keys for other collection services are ingested. Source Organization Collection Service 102 writes the primary keys to a file in google cloud storage 9 for E&D process 108 and returns the response back to Composer 6. Source Organization collection service 102 performs-search, insert or update operations, create primary key file, log audits, update staging table 5 on source organization. Note: Collection Services 110-128 are Python based API's residing in GKE Clusters 104.

Composer 6 invokes rest of the 8 Collection Services 110-128. GKE Clusters 104 spins up the required number of instances of each of the collection services 110-128 to perform the collection services operations 102. Each of the collection services 110-128 performs-search, insert or update operations, create primary key file, log audits, and update staging table 5.

Source Organization Collection Service 102 writes the primary key to Source Organization collection service primary keys file for all the transactions performed during the processing. This primary key file will be written to MIDAS cloud storage 9 for evaluation and decisioning process 108. Source Organization Collection service 102 validates the input and searches the input record in Source Organization collection service table 12; based on the search result—collection service will insert new record or update existing record in the respective collection staging tables 5 in the repository 14. Each of the Collection services writes the primary key to respective collection service primary keys file for all the transactions performed during the processing. Primary key files from each of the services will be written to MIDAS cloud storage for evaluation and decisioning process. Collection services validates the input and searches the input record in respective collection services tables; based on the search result-respective collection services will insert new record or update existing record in the respective collection staging tables 5 in the collection service repository 14.

Collection services 102 will log all the audits of collection services processes by writing structured log entries to GCP Cloud Logging 132, in GCP LogEntry JSON format. Collection services 102 will use the reference tables 12, 13 and 30 to lookup rules, source configurations and lists necessary to perform all the operations as part of collection process.

Google composer 6 (Airflow) will be set up to invoke Evaluation and Decisioning (E&D) process 108. E&D is scheduled to run on a time intervals. E&D reads all the primary key files and consolidates to create distinct list of primary keys that were impacted between the E&D processing intervals. E&D will use the reference tables 12, 13, and 30 to lookup rules, source configurations and lists necessary to perform all the operations as part of collection process.

E&D pulls all the related data associated with the primary keys and within their group for evaluation. E&D then evaluates the data sets by apply evaluation rules, invoking name and address identification services within E&D from rule configuration tables 30. E&D then determines final decision to be made based on the set of predefined configurable rules.

Decisioning of E&D process writes all the actions that will be decided as part of E&D process into decision repository 31 including the updates required to collection services tables 12, 13, and 30. E&D will log all the audits of collection services processes by writing structured log entries to GCP Cloud Logging 132, in GCP LogEntry JSON format. E&D will update the collection services tables 12, 13, and 30 as per the rules and based on the decisions taken as part of E&D process.

Once E&D process completes, composer 6 invokes Publisher 20 component to generate output file 132 for downstream application. Any decision that requires publishing of the data will be inserted into publisher tables 32 of MIDAS repository 7. Publisher 20 component will access the publisher tables 32 and will generate all the necessary output files and transfer file to downstream application 132 and archive the output file MIDAS storage (not shown). Publisher 20 will log all the audits of publication processes by writing structured log entries to GCP Cloud Logging 132, in GCP LogEntry JSON format.

MIDAS will publish output decisions for downstream consumers to MIDAS Publishing Bucket 22 where these transactions will be pushed to the downstream consumers (PRISM/ABUS, LDE, Global Match, Unity, iResearch, . . . )

A maintenance UI will expose the Configuration, Lookup Value, & Rule tables for CRUD operations.

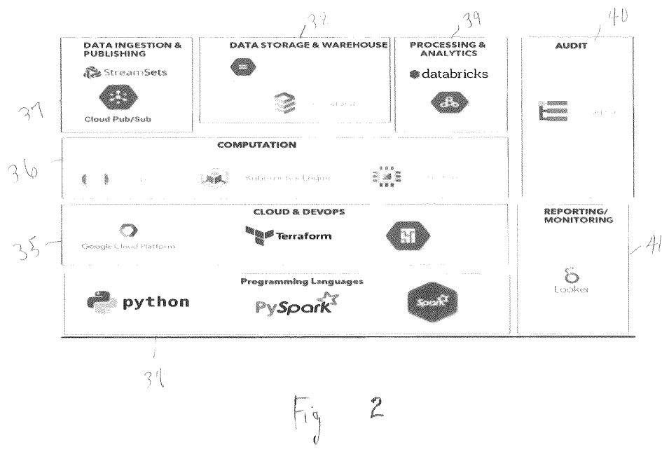

FIG. 2 is a block diagram depicting a MIDAS tech stack which comprises programming languages 34 (e.g., python pyspark and spark), cloud and devops 35 (e.g., Google cloud platform, Terraform, etc.), computation 36 (e.g., cloud functions, Kubernetes engine, and computer engine), data ingestion and publishing 37 (e.g., streamsets and cloud pug/sub), data storage and warehouse 38 (e.g., google cloud storage and cloud SQL), processing and analytics 39 (e.g., databricks), audit 40 (e.g., logging), and reporting and monitoring 41 (e.g., Looker).

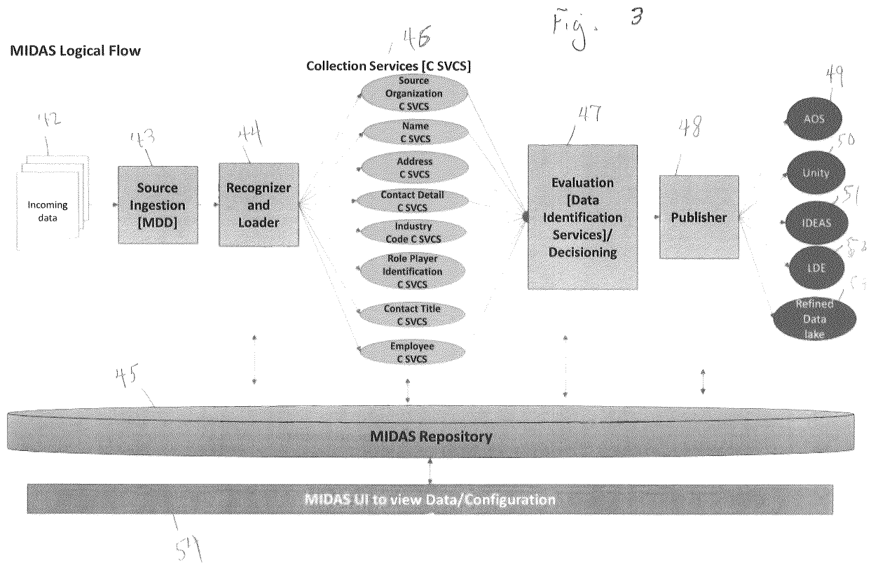

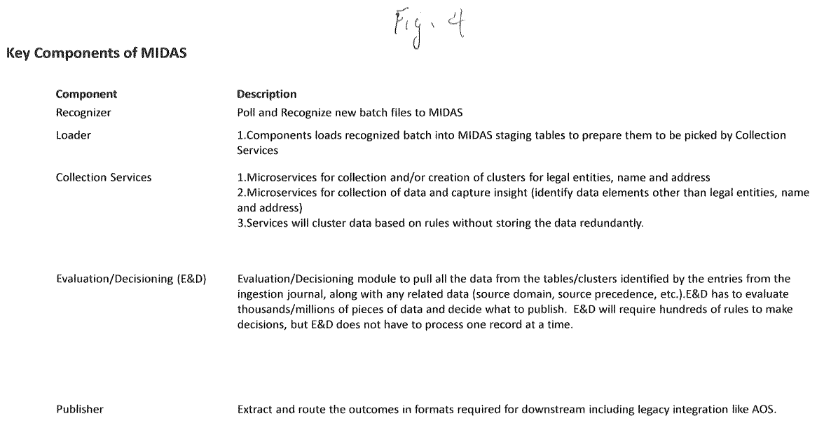

FIGS. 3 and 4 are brief logic flow diagram of the present disclosure with incoming data 42 being fed to source ingestion module (MDD) 43. Thereafter, the data in source ingestion 43 is sent to recognizer and loader engine 44 which polls and recognizes new batch files to MIDAS repository 45, and the loader components loads the recognized batch into MIDAS staging tables to prepare them to be picked by collection services enfine 46. Collection services engine 46 comprises at least one collection service selected from the group consisting of: source organization collection service, name collection service, address collection service, phone collection service, industry codes/line of business collecting service, role player identification collection service, contact title collection service, contact details collection service, start year collection service, employee collection service, URL/email collection service, and combinations thereof. The collection services data is also stored in MIDAS repository 45. The collection services provides (a) microservices for collection and/or creation of clusters for legal entities, name and address, (b) microservices for collection of data and capture insight (i.e., identify data elements other than legal entities, name and address), and (c) services will cluster data based on rules without storing the data redundantly.

Selected collection services data is then processed via an evaluation/decisioning module 47 (i.e., data identification services) from all of the data from the staging tables and/or the cluster data to determine which data to publish. Thereafter, a publisher module 48 publishes output decisions from the evaluation and decisioning module via AOS 49, unity 50, ideas 51, LDE 52 and/or refined data lake 53.

Finally, a MIDAS user interface 54 (UL) is used to view data/configuration based upon information provided by MIDAS repository 45.

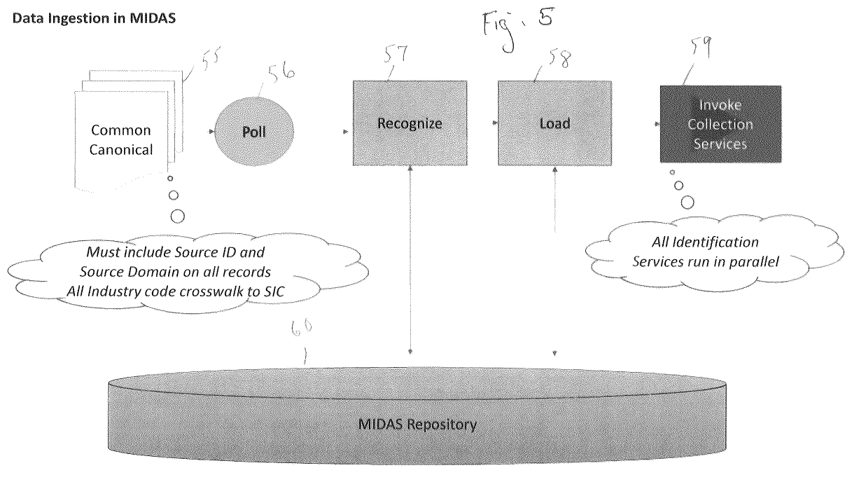

FIG. 5 is a logic flow diagram depicting a data ingestion according to MIDAS. That is common canonical data 55 (i.e., source identification and source domain on all records, and all industry code crosswalk to SIC), is polled 56, recognized 57, loaded 58, and invoke collection services 59, i.e., all identification services are run in parallel. Recognized and loaded data from recognizer unit 57 and loader unit 58 are stored in MIDAS repository 60.

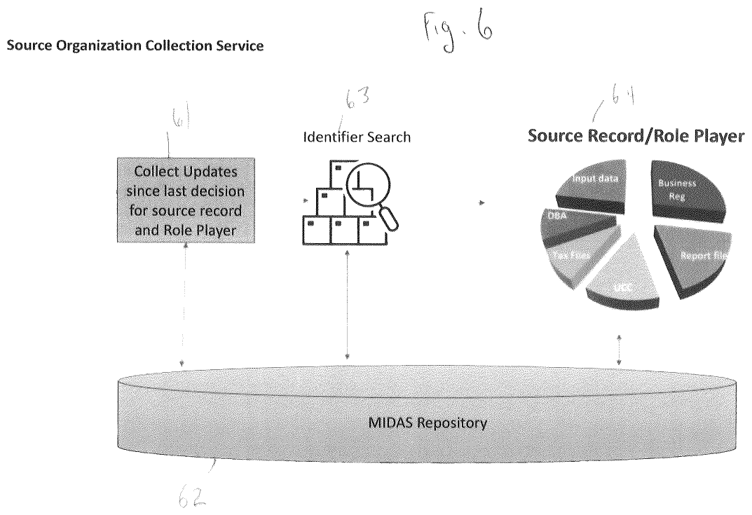

FIG. 6 is a logic flow diagram depicting a source organization collection service, wherein the collection services engine collects updates 61 since the last decision for source record and role player from MIDAS repository 62, and then performs an identifier search 63 based upon source record/role player inputs 64.

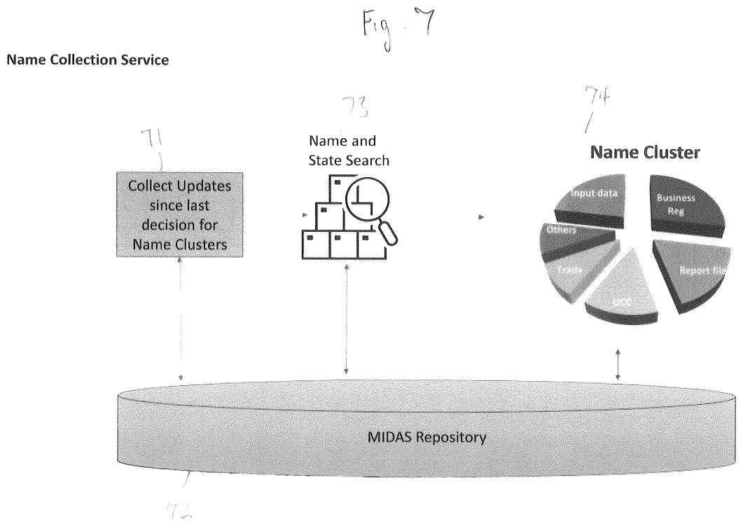

FIG. 7 is a logic flow diagram depicting a name collection service, wherein the collection services engine collects updates 71 since the last decision for name cluster from MIDAS repository 72, and then performs a name and state search 73 based upon name cluster inputs 74.

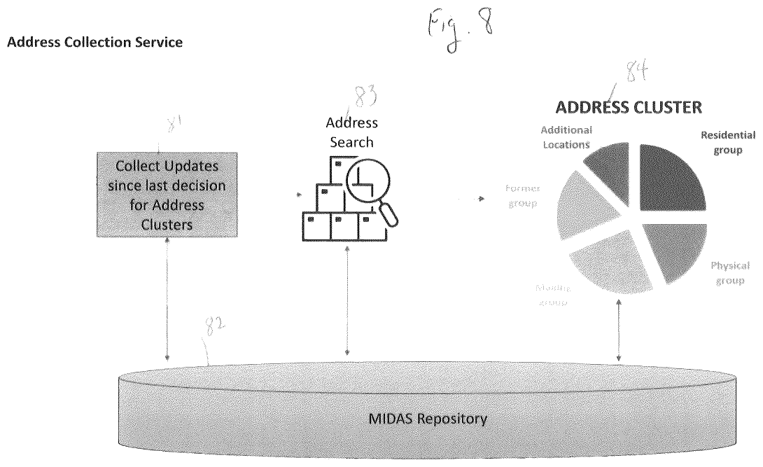

FIG. 8 is a logic flow diagram depicting an address collection service, wherein the collection services engine collects updates 81 since the last decision for address cluster from MIDAS repository 82, and then performs an address search 83 based upon address cluster inputs 84.

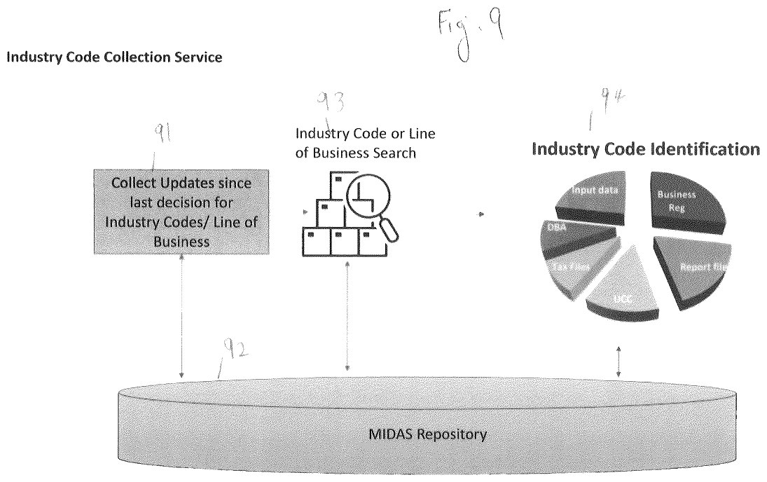

FIG. 9 is a logic flow diagram depicting an industry code collection service, wherein the collection services engine collects updates 91 since the last decision for industry codes and line of business (SIC codes) from MIDAS repository 92, and then performs an industry code identification search 93 based upon address cluster inputs 94.

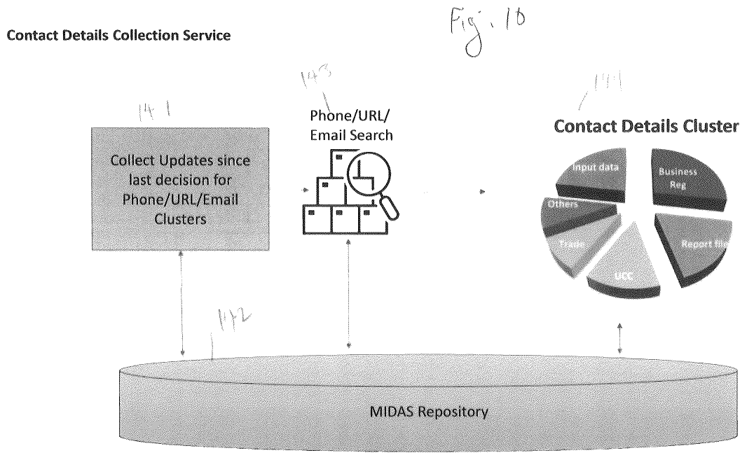

FIG. 10 is a logic flow diagram depicting a contact details collection service, wherein the collection services engine collects updates 141 since the last decision for a phone, URL or email clusters from MIDAS repository 142, and then performs a phone, URL and/or email cluster search 143 based upon contact details cluster inputs 144.

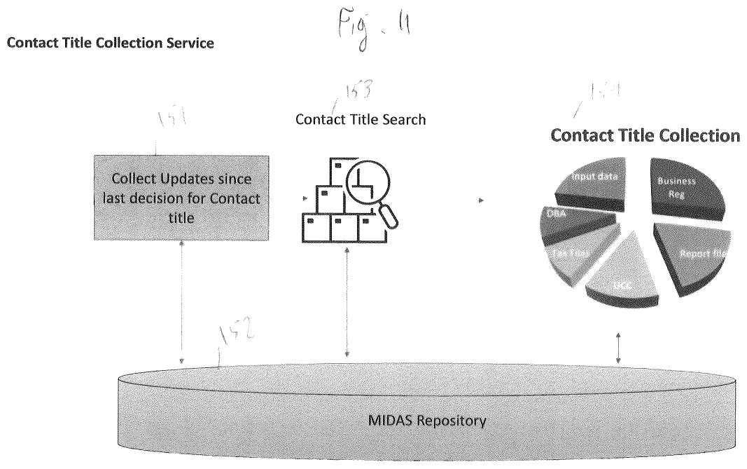

FIG. 11 is a logic flow diagram depicting a contact title collection service, wherein the collection services engine collects updates 151 since the last decision for a contact title from MIDAS repository 152, and then performs contact title search 153 based upon contact details cluster inputs 154.

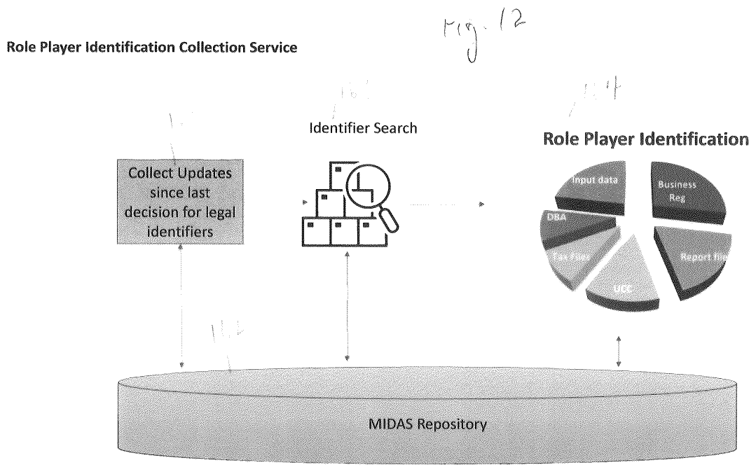

FIG. 12 is a logic flow diagram depicting a contact title collection service, wherein the collection services engine collects updates 161 since the last decision for a role player identification from MIDAS repository 162, and then performs identifier search 163 based upon role player identification inputs 164.

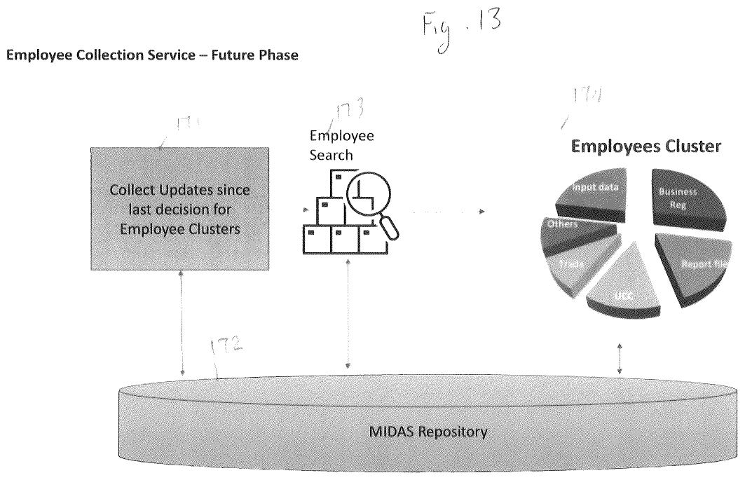

FIG. 13 is a logic flow diagram depicting an employee collection service, wherein the collection services engine collects updates 171 since the last decision for employee clusters from MIDAS repository 172, and then performs employee search 173 based upon an employee cluster inputs 174.

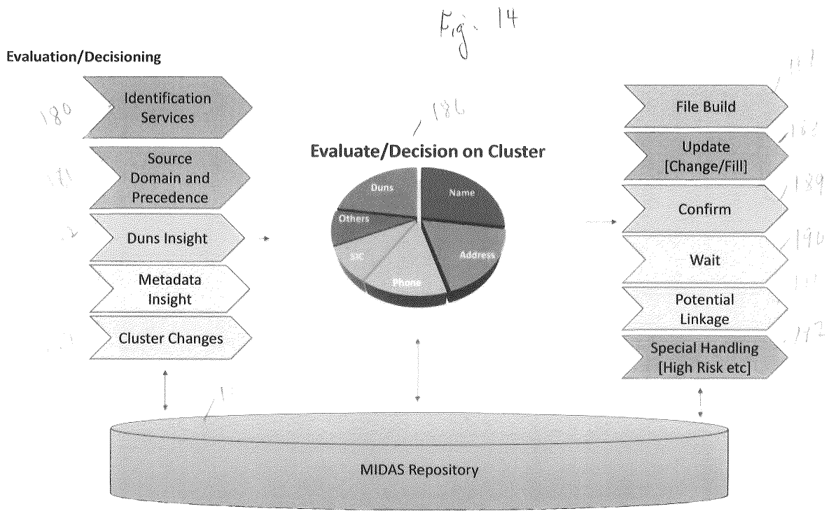

FIG. 14 is a graphic representation of the evaluation/decisioning module, wherein source data selected from identification services 180, source domain and precedence 181, Duns Insight 182, metadata insight 183 and cluster changes 184 retrieved from MIDAS repository 185 are processed to evaluate/decision on cluster 186, and thereby generating a file build 187, update (change/fill) 188, confirm 189, wait 190, potential linkage 191, and special handling (high risk, etc.) 192.

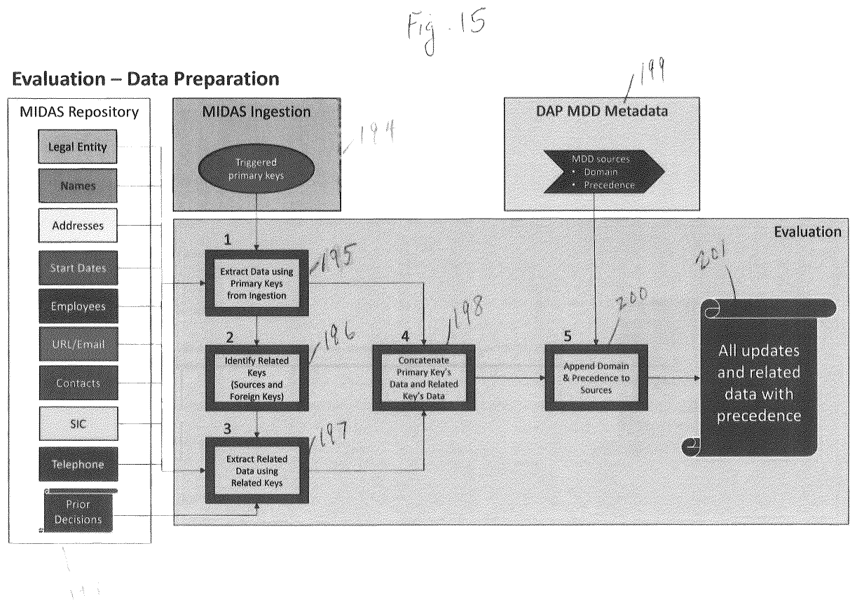

FIG. 15 is a block diagram of data preparation for the evaluation step, wherein MIDAS repository data 193 and MIDAS ingestion data 194 with triggered primary keys are extracted using primary keys from ingestion 195 followed by identifying related keys (i.e., sources and foreign keys) 196 and extraction of related data using related keys 197. Thereafter, extracted data using primary keys from ingestion and extracted related data using related keys are concatenated 198. MDD metadata 199 such as MDD sources domain and precedence sources are appended to the concatenate data 200, such that all updates and related data with precedence 201.

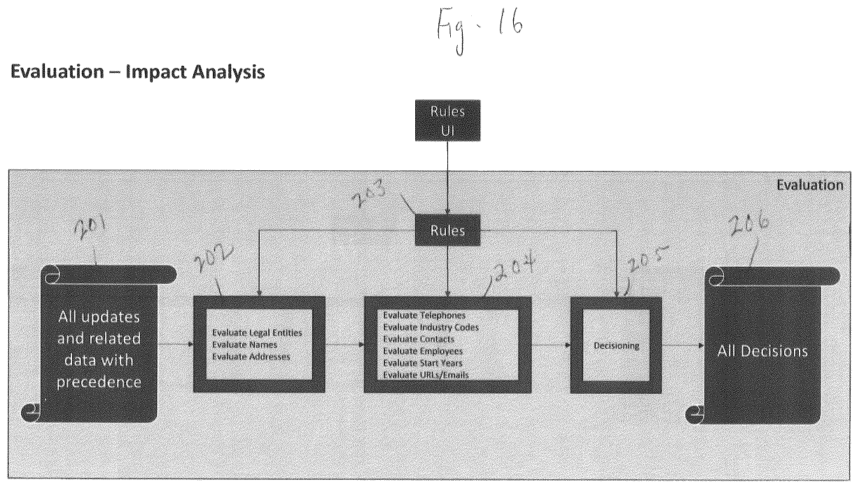

FIG. 16 is a block diagram of the evaluation impact analysis according to MIDAS, wherein updates and related data with precedence 201 have rules 203 applied thereto to evaluate legal entities, names, and addresses 202 followed by evaluating telephone numbers, industry codes, contact, employees, start years and URLs/Emails 204. Thereafter, rules 203 are also applied to decisioning 205 (i.e., decisioning actions include (a) publish a new record or an update to an existing record, (b) defer and wait for corroborating data, and (c) ignore because data agrees with the source information which generates all decisions 206.

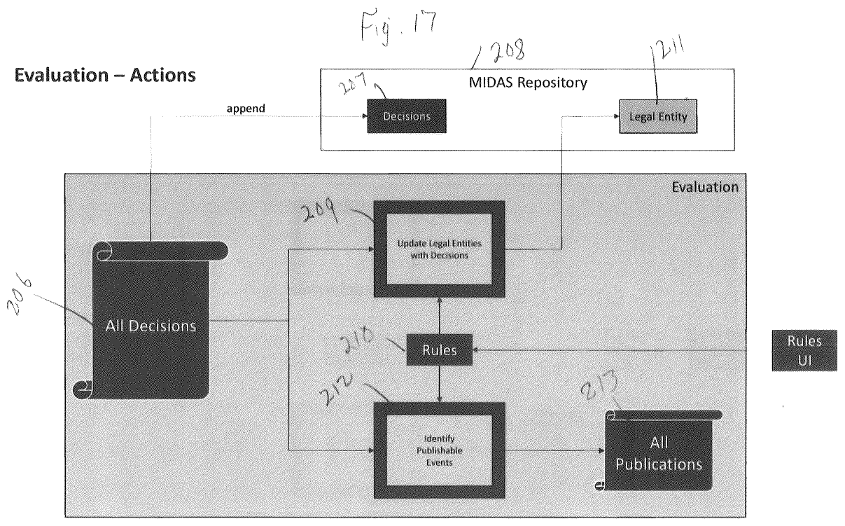

FIG. 17 is a block diagram of the evaluation actions according to MIDAS, wherein all decisions 206 are appended decisions 207 and stored in the MIDAS repository 208. Moreover, all decisions 206 are combined with updated legal entities 209 based upon rules 210 and stored in legal entity 211 file in MIDAS repository 208. In addition, all decisions 206 also use rule 210 to identify publishable events 212 associated with such decisions 206, thereby generating all publications 213.

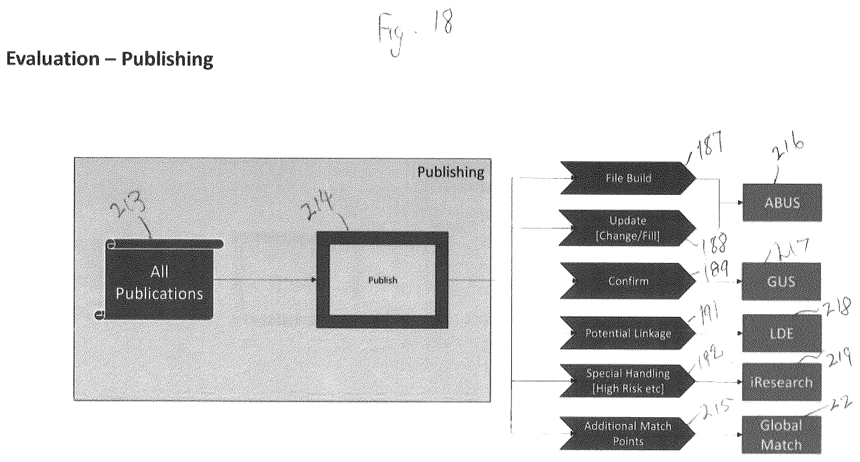

FIG. 18 is a block diagram of the evaluation publishing, wherein all publications 213 are published 214 with file build 187, update (change/fill) 188, confirm 189, potential linkage 191, special handling (high risk, etc.) 192 and additional match points 215. File build 187 and update 188 are transmitted to ABUS 216. Confirm 189 is transmitted to GUS 217. Potential linkage 191 is transmitted to LDE 218. Special handling 192 is transmitted to iResearch 219. And additional match points 215 are transmitted to global match 220.

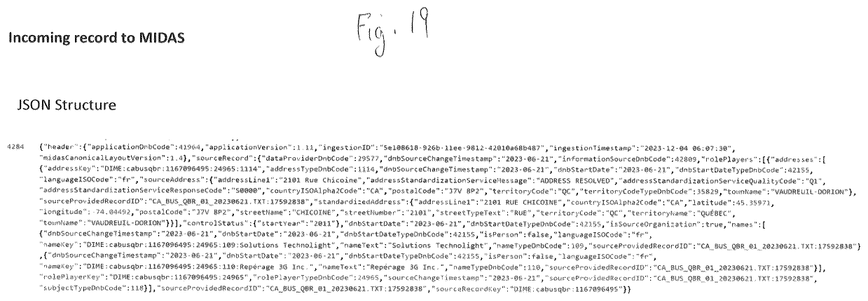

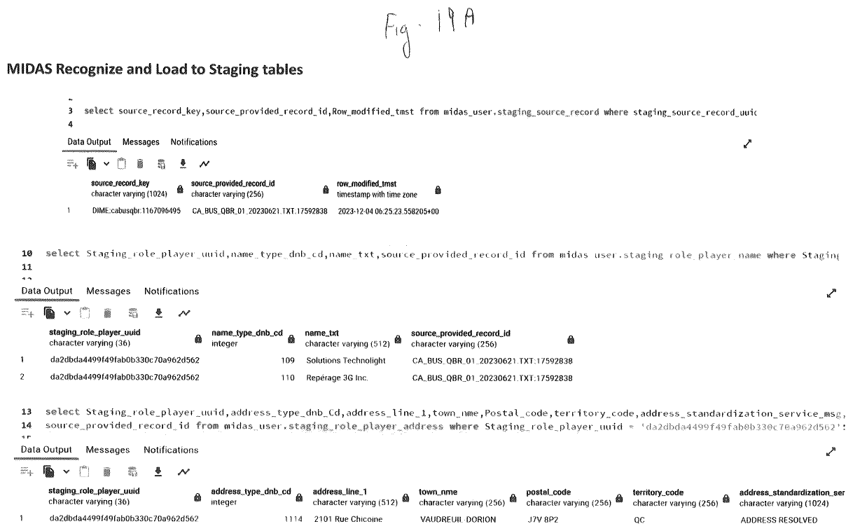

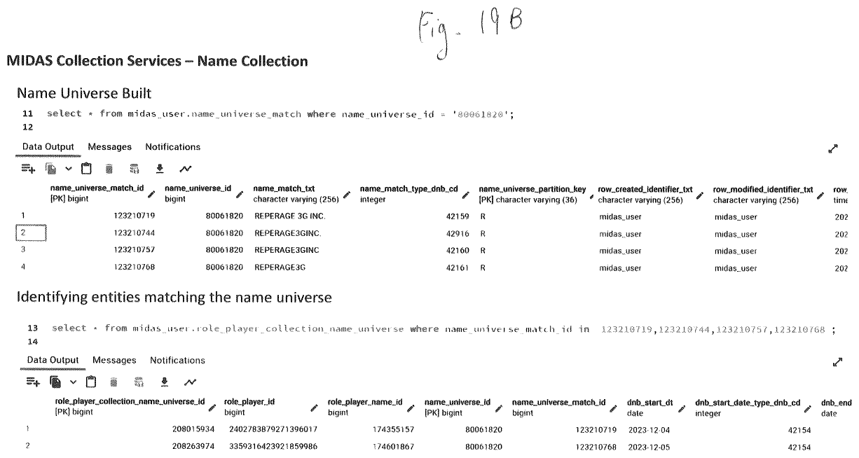

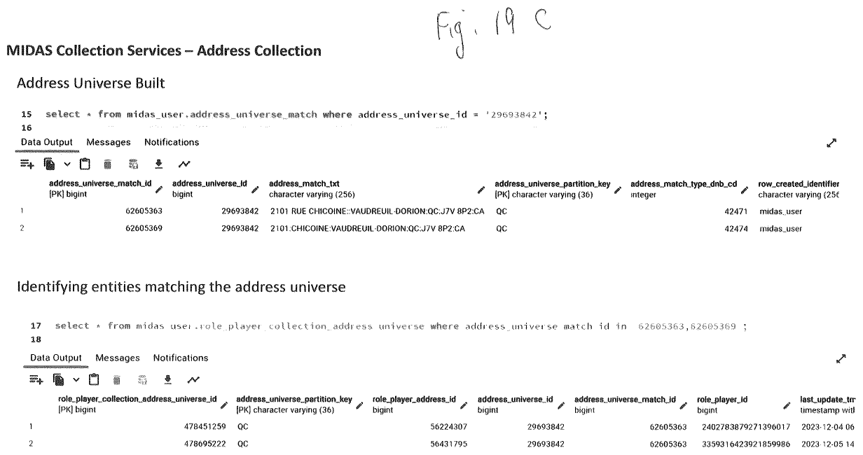

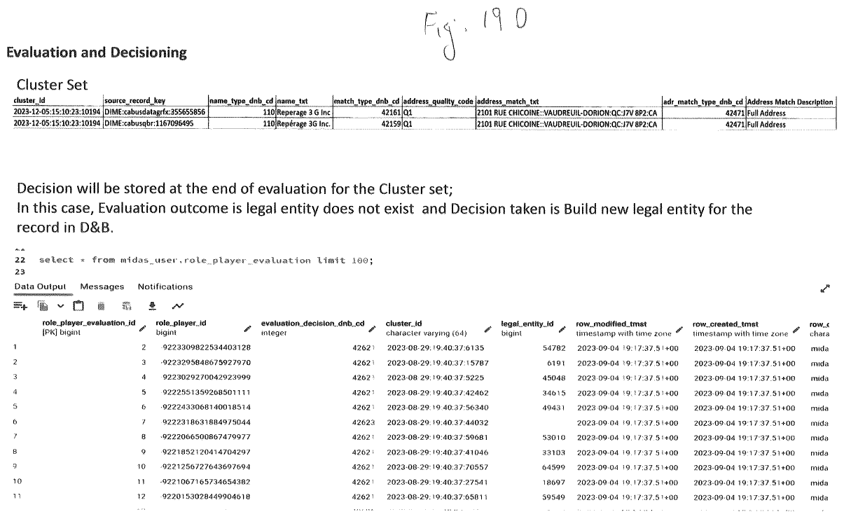

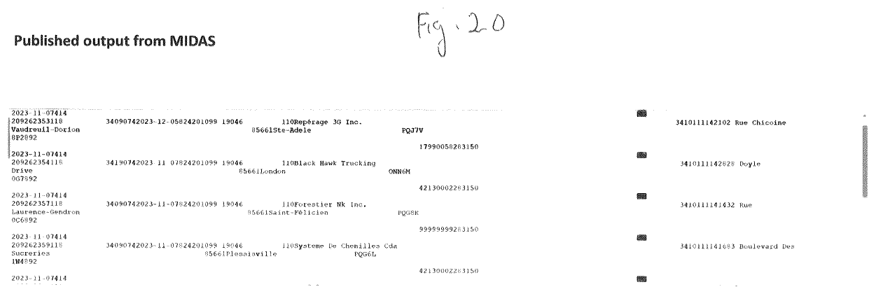

FIG. 19 depicts an incoming record to MIDAS in JSON structure. FIG. 19A depicts how MIDAS recognizes and loads to staging tables. FIG. 19B is collection services for name collections for name universe built and identifying entities matching the name universe. FIG. 19C is collection services for address collection for address universe built and identifying entities matching the address universe. FIG. 19D is an evaluation and decisioning depicting a cluster set which decision will be stored at the end of evaluation for the cluster set. In the case shown, the evaluation outcome is that the legal entity does not exist and hence the decision taken is to build a new legal entity for the master database. FIG. 20 is a published output from MIDAS.

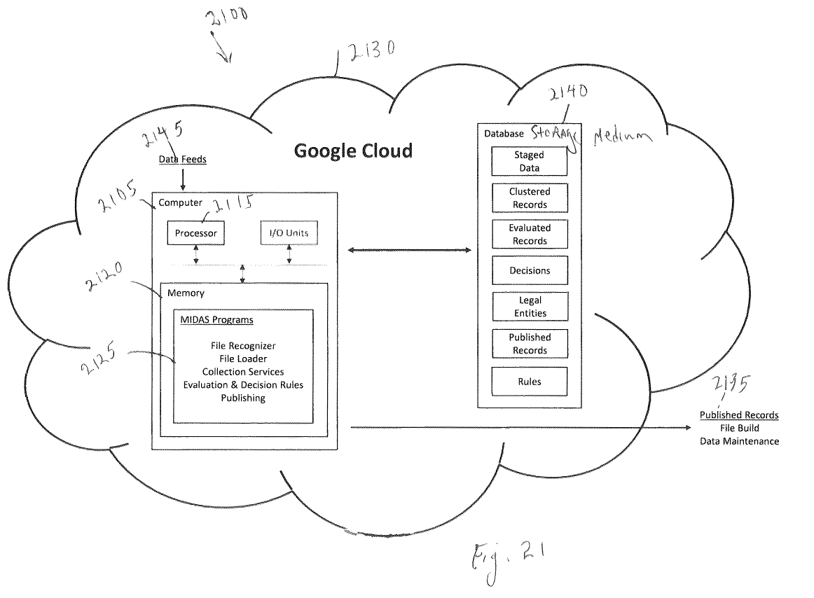

FIG. 21 is a block diagram of a system 2100, for employment of the present invention. System 2100 includes a computer 2105 coupled to a network 2106, e.g., the Internet.

Computer 2105 includes a user interface 2110, a processor 2115, and a memory 2120. Computer 2105 may be implemented on a general-purpose microcomputer. Although computer 2105 is represented herein as a standalone device, it is not limited to such, but instead can be coupled to other devices (not shown) via cloud network 2130.

Processor 2115 is configured with logic circuitry that responds to and executes instructions.

Memory 2120 stores data and instructions for controlling the operation of processor 2115. Memory 2120 may be implemented in a random-access memory (RAM), a hard drive, a read only memory (ROM), or a combination thereof. One of the components of memory 2120 is a program module 2125 which includes, but is not limited to, a file recognizer, file loader, collection services, evaluation & decision rules, and publishing.

Program module 2125 contains instructions for controlling processor 2115 to execute the methods described herein. The term “module” is used herein to denote a functional operation that may be embodied either as a stand-alone component or as an integrated configuration of a plurality of sub-ordinate components. Thus, program module 2125 may be implemented as a single module or as a plurality of modules that operate in cooperation with one another. Moreover, although program module 2125 is described herein as being installed in memory 2120, and therefore being implemented in software, it could be implemented in any of hardware (e.g., electronic circuitry), firmware, software, or a combination thereof.

The user interface not shown includes an input device, such as a keyboard or speech recognition subsystem, for enabling a user to communicate information and command selections to processor 2115. User interface also includes an output device such as a display or a printer of the published records 2135. A cursor control such as a mouse, trackball, or joystick, allows the user to manipulate a cursor on the display for communicating additional information and command selections to processor 2115.

Processor 2115 outputs, to user interface, a result of an execution of the methods described herein. Alternatively, processor 2115 could direct the output to a remote device (not shown) via cloud network 2130.

While program module 2125 is indicated as already loaded into memory 2120, it may be configured on a storage medium 2140 for subsequent loading into memory 2120. Storage medium 2140 can be any conventional storage medium that stores program module 2125 thereon in tangible form. Examples of storage medium 2140 include a floppy disk, a compact disk, a magnetic tape, a read only memory, an optical storage media, universal serial bus (USB) flash drive, a digital versatile disc, or a zip drive. Alternatively, storage medium 2140 can be a random-access memory, or other type of electronic storage, located on a remote storage system and coupled to computer 2105 via cloud network 2130. Database storage medium 2140 can also store at least one selected from the group consisting of: staged data, clustered records, evaluated records, decisions, legal entities, published records, and rules. Finally, data is ingested into MIDAS vis data feeds 2145.

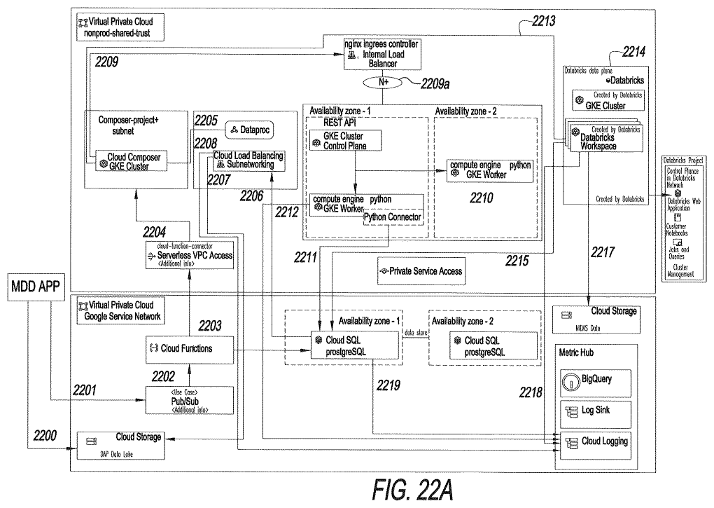

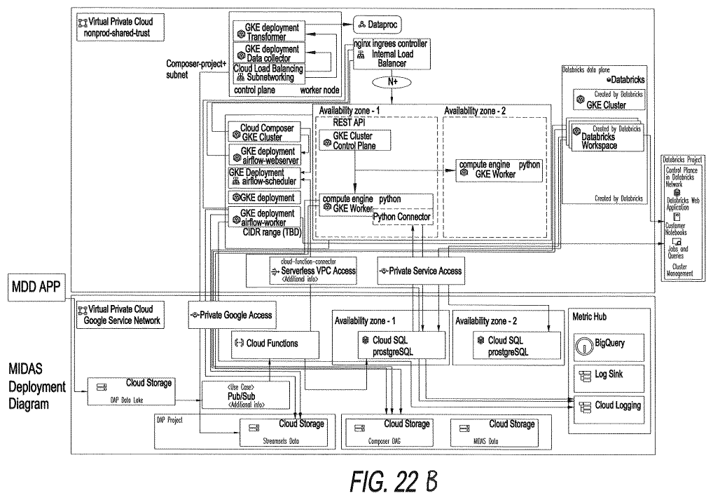

FIGS. 22A and B are block flow MIDAS deployment diagrams according to the present disclosure wherein MIDAS deployment device (MDD) application 43 generates a file 2200 for MIDAS to consume in cloud storage 2300. MDD application 43 also posts a Pub/Sub message 2201 regarding the file 220 generated and location of the file in the cloud storage 2300. MIDAS Recognizer 2202 reads the Pub/Sub message 2201. Then MIDAS recognizer 2202 writes the Pub/Sub message 2201 content into processing table cloud functions 2203 in the MIDAS database 2203a. Furthermore, MIDAS recognizer 2202 invokes airflow (cloud composer 2204a) 2204 to trigger the MIDAS loader workflow. Airflow 2204 and cloud composer 2204a invokes MIDAS loader component 2205. MIDAS loader 2205 reads the path, and the file name details in the processing table 2206 stored in the MIDAS database. That is, MIDAS loader 2205 fetches the file from cloud storage 2300 and ingests the data into the topic staging tables 2207 (i.e., source records, names, address, industry codes, etc.). MIDAS loader 2205 writes the logs to the metric hub 2217b for observability. Airflow scheduler 2209 invokes MIDAS collection services 2207a on scheduled intervals, while loader balancer 2209a of collection services 2207a distributes the workload. MIDAS collection services 2210 fetches 200,000 records from staging tables 2207 and searches the topical universes. MIDAS collection services 2210 updates collection tables 2211, and writes the logs 2212 to metric hub 2217b for observability. Airflow scheduler 2209 invokes MIDAS evaluation and decisioning 2213 on scheduled intervals and spins up data bricks cluster 2214. Thereafter, MIDAS evaluation extracts the data from collection tables updated since the last cycle 2215. MIDAS evaluation applies rules, and the decisions are recorded in the legal entity tables 2216.

MIDAS publishes transactions 2217 to build a new DUNS (i.e., corporate entity number) record or update an existing DUNS record into cloud storage 2217a. Moreover, MIDAS evaluation & decisioning write logs 2218 to metrics hub 2217b. MIDAS database 2203a write logs 2219 to metrics hub 2217b for observability. MIDAS then transfers output 2220 to downstream application.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A master ingestion and data automation system which comprises:
a. a source ingestion module which receives incoming files of meta data driven framework (MDD) which standardizes and normalizes data using source-specific rules;
b. a recognizer engine which receives said incoming files to poll and recognize new files into said master ingestion and data automation system as recognized files;
c. a loader which loads said recognized files into staging tables;
d. a collection services engine, wherein said collection services engine processes said recognized files by:
i. collecting and/or creating at least one cluster of legal entities, names, and/or addresses;
ii. collecting data and capturing insights other than said legal entities, names, and/or addresses; and
iii. cluster data based on rules without storing said data redundantly;
e. an evaluation and decisioning module that retrieves all of the data from said staging tables and/or said cluster data to determine which data to publish; and
f. a publisher module which publishes output decisions from said evaluation and decisioning module.

2. The system according to claim 1, wherein said incoming files are batch files.

3. The system according to claim 1, wherein said data from said staging tables and/or cluster data are identified by entries from an ingestion journal together with any related data comprising source domain and precedence.

4. The system according to claim 1, wherein said collection services engine comprises at least one GKE cluster containing a python API.

5. The system according to claim 1, wherein said collection services engine comprises at least one collection service selected from the group consisting of: source organization collection service, name collection service, address collection service, phone collection service, industry codes/line of business collecting service, role player identification collection service, contact title collection service, contact details collection service, start year collection service, employee collection service, URL/email collection service, and combinations thereof.

6. The system according to claim 5, wherein said data from said staging tables and/or said cluster data are stored in a collection service repository after being processed in said at least one collection service.

7. The system according to claim 6, wherein said cluster data is updates since the last decision for at least one cluster selected from the group consisting of: name clusters, address clusters, industry codes/line of business identification, contact details clusters, contact title collection, role player identification, employee clusters, and combinations thereof.

8. The system according to claim 5, wherein said evaluation and decisioning module receives data from at least one data source selected from the group consisting of: said at least one collection service, source and domain precedence, Duns insight, metadata insight, cluster changes, and combinations thereof.

9. The system according to claim 1, wherein said data to publish is at least one selected from the group consisting of: file build, update (change/fill), confirm, wait, potential linkage, special handling (high risk), and additional match points.

10. A method for ingesting data automatically which comprises:
a. receiving incoming files of meta data driven framework (MDD), and using source-specific rules to standardize and normalize said data;
b. receiving said incoming files to poll and recognize new files into said master ingestion and data automation system as recognized files;
c. loading said recognized files into staging tables;
d. processing said recognized files via a collection services engine by:
i. collecting and/or creating at least one cluster of legal entities, names, and/or addresses;
ii. collecting data and capturing insights other than said legal entities, names, and/or addresses; and
iii. cluster data based on rules without storing said data redundantly;
e. retrieving all of the data from said staging tables and/or said cluster data to determine which data to publish via an evaluation and decisioning module; and
f. publishing output decisions from said evaluation and decisioning module via a publisher module.

11. The method according to claim 10, wherein said incoming files are batch files.

12. The method according to claim 10, further comprising identifying said data from said staging tables and/or cluster data by entries from an ingestion journal together with any related data comprising source domain and precedence.

13. The method according to claim 10, wherein said collection services engine comprises at least one GKE cluster containing a python API.

14. The method according to claim 10, wherein said collection services engine comprises at least one collection service selected from the group consisting of: source organization collection service, name collection service, address collection service, phone collection service, industry codes/line of business collecting service, role player identification collection service, contact title collection service, contact details collection service, start year collection service, employee collection service, URL/email collection service, and combinations thereof.

15. The method according to claim 14, wherein said data from said staging tables and/or said cluster data are stored in a collection service repository after being processed in said at least one collection service.

16. The method according to claim 15, wherein said cluster data is updates since the last decision for at least one cluster selected from the group consisting of: name clusters, address clusters, industry codes/line of business identification, contact details clusters, contact title collection, role player identification, employee clusters, and combinations thereof.

17. The method according to claim 14 wherein said evaluation and decisioning module receives data from at least one data source selected from the group consisting of: said at least one collection service, source and domain precedence, Duns insight, metadata insight, cluster changes, and combinations thereof.

18. The method according to claim 10, wherein said data to publish is at least one selected from the group consisting of: file build, update (change/fill), confirm, wait, potential linkage, special handling (high risk), and additional match points.

19. A non-transitory computer readable storage media containing executable computer program instructions which when executed cause a processing system to perform a method for ingesting data automatically which comprises:
a. receiving incoming files of meta data driven framework (MDD), and using source-specific rules to standardize and normalize said data;
b. receiving said incoming files to poll and recognize new files into said master ingestion and data automation system as recognized files;
c. loading said recognized files into staging tables;
d. processing said recognized files via a collection services engine by:
i. collecting and/or creating at least one cluster of legal entities, names, and/or addresses;
ii. collecting data and capturing insights other than said legal entities, names, and/or addresses; and
iii. cluster data based on rules without storing said data redundantly;
e. retrieving all of the data from said staging tables and/or said cluster data to determine which data to publish via an evaluation and decisioning module; and
f. publishing output decisions from said evaluation and decisioning module via a publisher module.
